(19) United States
(12) Patent Application Publication
(10) Pub. No.: US 2025/0036764 A1
(43) Pub. Date: Jan. 30, 2025

(54) ATTACK ANALYSIS SUPPORT APPARATUS, ATTACK ANALYSIS SUPPORT METHOD, AND COMPUTER-READABLE RECORDING MEDIUM

(71) Applicant: NEC Corporation, Minato-ku, Tokyo (JP)

(72) Inventors: Shohei HIRUTA, Tokyo (JP); Satoshi IKEDA, Tokyo (JP)

(73) Assignee: NEC Corporation, Minato-ku, Tokyo (JP)

(21) Appl. No.: 18/688,419

(22) PCT Filed: Sep. 17, 2021
(86) PCT No.: PCT/JP2021/034337

§ 371 Date: Mar. 1, 2024

(51) Int. Cl. G06F 21/56; G06F 21/55

(52) U.S. Cl. CPC G06F 21/566; G06F 21/552

(57) ABSTRACT

An attack analysis support apparatus includes: an acquiring unit that acquires a predicate indicating a type of an attack included in an observation indicating a trace of the attack, or an observation type indicating a type of the observation corresponding to the predicate; a noise condition generating unit that generates a noise condition by, with use of selection information that is included in conversion information associated with the predicate or the observation type and is for selecting conversion target data included in log management information for managing a log, selecting conversion target data from the log management information, and converting the selected conversion target data based on conversion method information included in the conversion information; and a noise information generating unit that generates noise information to be used for determination of whether or not the observation is noise, in accordance with the noise condition generated for the log management information.

### TECHNICAL FIELD

The technical field relates to an attack analysis support apparatus and an attack analysis support method for supporting analysis of a cyber attack, and further relates to a computer-readable recording medium that records a program for realizing these.

### BACKGROUND ART

In order to improve the work efficiency of an analyst who performs cyber attack analysis, systems for supporting analysis have been proposed. In one known system, an attack technique is logically inferred using observations, and the logically inferred attack technique is presented to an analyst.

An observation is data obtained by detecting a trace of an attack from a log acquired from the attack target system, and then performing conversion into a format that can be handled by logical inference. An attack technique is a sequence of attack operations. For example, in such a sequence, a tool is executed, an internal search is performed, communication is established with a command and control (C&C) server, and information is taken away:

Logical inference is processing for deducing an attack technique based on a trace of an attack. For example, in the case where a tool was executed, the trace is a log indicating that the tool was executed. In the case where an internal search was performed, the trace is the execution of a connection check command on a terminal. In the case where communication was established with a C&C server, the trace is periodic and quantitative communication from a terminal. In the case where information was taken away, the trace is the external transmission of a large amount of data.

However, if an observation is not related to an attack, that is to say, if an observation is noise generated for a trace of normal operation, the accuracy of logical inference decreases, and the execution time of logical inference increases. Therefore, noise needs to be reduced. Noise refers to traces of an operating system (OS) update, antivirus software operations, and the like.

As one example of a related technique, Patent Document 1 discloses an information processing device that reduces the amount of information in log information. According to the information processing device of Patent Document 1, if log information for a certain process matches information in a whitelist (log information that has already been output), that log information is not output, whereas if the log information of the process does not match information in the whitelist, the log information is output and also added to the whitelist.

As another example of a related technique, Patent Document 2 discloses a malware feature extraction system for effectively extracting malware-attributed behavior from a log acquired by dynamically analyzing malware. According to the malware feature extraction system of Patent Document 2, a malware analysis log is obtained by executing a program associated with malware, and the portion thereof not included in a regular file analysis log obtained by executing a program associated with a regular file (non-malware file) is extracted as a malware-related black log.

### LIST OF RELATED ART DOCUMENTS

### Patent Document

Patent Document 1: Japanese Patent Laid-Open Publication No. 2014-170327
Patent Document 2: Japanese Patent Laid-Open Publication No. 2015-225512

### SUMMARY OF INVENTION

### Problems to be Solved by the Invention

However, in the information processing device of Patent Document 1, the format of log information is fixed to a specific format. Therefore, with the information processing device of Patent Document 1, information for reducing noise cannot be generated in accordance with a type of attack.

Furthermore, in the malware feature extraction system of Patent Document 2, portions of a log that do not correspond to malware are considered to be noise and are removed. Even when multiple attacks are performed by the same malware, the behavior of the malware changes depending on the target of the attack or the time of the attack (year, month, day, and time), and therefore a behavior that does not match actually has a high possibility of being an attack. Therefore, in the malware feature extraction system of Patent Document 2, a trace of an attack may be considered to be noise and removed.

As one aspect, it is an object to provide an attack analysis support apparatus, an attack analysis support method, and a computer-readable recording medium that generate information for reducing noise according to the type of attack.

### Means for Solving the Problems

In order to achieve the example object described above, an attack analysis support apparatus according to an example aspect includes:
an acquiring means for acquiring a predicate indicating a type of an attack included in an observation indicating a trace of the attack, or an observation type indicating a type of the observation corresponding to the predicate;
a noise condition generating means for generating a noise condition by, with use of selection information that is included in conversion information associated with the predicate or the observation type and is for selecting conversion target data included in log management information for managing a log, selecting conversion target data from the log management information, and converting the selected conversion target data based on conversion method information included in the conversion information; and
a noise information generating means for generating noise information to be used for determination of whether or not the observation is noise, in accordance with the noise condition generated for the log management information.

Also, in order to achieve the example object described above, an attack analysis support method according to an example aspect, a computer includes:
an acquiring step of acquiring a predicate indicating a type of an attack included in an observation indicating a trace of the attack, or an observation type indicating a type of the observation corresponding to the predicate;
a noise condition generating step of generating a noise condition by, with use of selection information that is included in conversion information associated with the predicate or the observation type and is for selecting conversion target data included in log management information for managing a log, selecting conversion target data from the log management information, and converting the selected conversion target data based on conversion method information included in the conversion information; and
a noise information generating step of generating noise information to be used for determination of whether or not the observation is noise, in accordance with the noise condition generated for the log management information.

Furthermore, in order to achieve the example object described above, a computer-readable recording medium according to an example aspect includes a program recorded on the computer-readable recording medium, the program including instructions that cause the computer to carry out:
an acquiring step of acquiring a predicate indicating a type of an attack included in an observation indicating a trace of the attack, or an observation type indicating a type of the observation corresponding to the predicate;
a noise condition generating step of generating a noise condition by, with use of selection information that is included in conversion information associated with the predicate or the observation type and is for selecting conversion target data included in log management information for managing a log, selecting conversion target data from the log management information, and converting the selected conversion target data based on conversion method information included in the conversion information; and
a noise information generating step of generating noise information to be used for determination of whether or not the observation is noise, in accordance with the noise condition generated for the log management information.

### Advantageous Effects of the Invention

As one aspect, it is possible to generate information for reducing noise according to the type of attack.

### BRIEF DESCRIPTION OF THE DRAWINGS

FIG. 1 is a diagram for describing an example of an attack analysis support apparatus of the first example embodiment.

FIG. 2 is a diagram for describing an example of a system that includes the attack analysis support apparatus of the first example embodiment.

FIG. 3 is a diagram for describing an example of an observation.

FIG. 4 is a diagram for describing an example of observation information.

FIG. 5 is a diagram for describing an example of observation management information.

FIG. 6 is a diagram for describing an example of log management information.

FIG. 7 is a diagram for describing an example of observation type information.

FIG. 8 is a diagram for describing an example of conversion information correspondence management information.

FIG. 9 is a diagram for describing an example of conversion information management information.

FIG. 10 is a diagram for describing an example of noise condition management information.

FIG. 11 is a diagram for describing an example of noise information management information.

FIG. 12 is a diagram for describing an example of operation of the attack analysis support apparatus according to the first example embodiment.

FIG. 13 is a diagram for describing an example of a system including an attack analysis support apparatus of the first example modification.

FIG. 14 is a diagram for describing an example of operations of the attack analysis support apparatus in first example modification.

FIG. 15 is a diagram for describing an example of a system that includes the attack analysis support apparatus of the second example embodiment.

FIG. 16 shows information for describing an example of noise determination information.

FIG. 17 is a diagram for describing an example of operation of the attack analysis support apparatus of the second example embodiment.

FIG. 18 is a diagram for describing an example of a system that includes the attack analysis support apparatus of the third example embodiment.

FIG. 19 is a diagram for showing an example of a computer that realizes the attack analysis support apparatus in the first example embodiment, the first example modification, the second example embodiment and the third example embodiment.

### EXAMPLE EMBODIMENTS

Example embodiments will be described below with reference to the drawings. Note that in the drawings described below; elements having the same or corresponding functions are denoted by the same reference numerals, and repeated description thereof may be omitted.

### First Example Embodiment

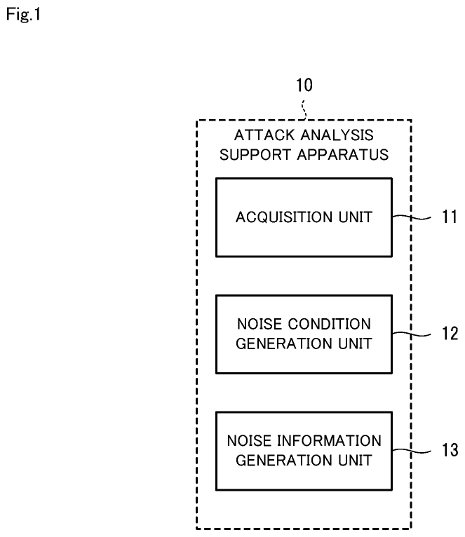

The following describes the configuration of an attack analysis support apparatus 10 in a first example embodiment with reference to FIG. 1. FIG. 1 is a diagram for describing an example of an attack analysis support apparatus of the first example embodiment.

### [Apparatus Configuration]

The attack analysis support apparatus 10 shown in FIG. 1 generates information for reducing noise in accordance with a type of attack. Also, as shown in FIG. 1, the attack analysis support apparatus 10 includes an acquisition unit 11, a noise condition generation unit 12, and a noise information generation unit 13.

The acquisition unit 11 acquires a predicate indicating the type of an attack included in an observation indicating a trace of the attack, or an observation type indicating the type of observation corresponding to the predicate, as well as a log that corresponds to the predicate or the observation type.

An observation is information generated by analyzing a log. For example, in the case where process logs are analyzed and a trace of execution of the program “Mimikatz”, which steals user authentication information, is detected, the observation that “Mimikatz” was executed is generated based the corresponding processing log.

As another example, in the case where registry logs are analyzed and a trace of registration of a suspicious program in the Run key is detected, the observation that a suspicious program was registered in the Run key is generated based the corresponding registry log.

A predicate is information indicating a type of attack. For example, if a program that steals authentication information was executed, the predicate indicates “CredentialDumping” or the like. As another example, if persistence (automatic execution: periodic attack execution) was set using the Run key in the registry, the predicate indicates “PersistByRunKey” or the like.

An observation type is information indicating the type of observation that corresponds to a predicate. For example, if the predicate is “CredentialDumping.” the observation type indicates “process” or the like. As another example, if the predicate is “PersistByRunKey”, the observation type indicates “persistence” or the like.

The noise condition generation unit 12 generates a noise condition by, with use of selection information that is included in conversion information associated with the predicate or the observation type and is for selecting conversion target data included in log management information for managing a log, selecting conversion target data from the log management information, and converting the selected conversion target data based on conversion method information included in the conversion information.

Conversion information is information used to convert conversion target data associated with a predicate or an observation type to generate a noise condition. The conversion information includes selection information for selecting conversion target data from log management information, and conversion method information indicating a method for converting the selected conversion target data, for example.

Log management information is information for managing logs that include traces of attacks. The log management information includes conversion target data.

For example, when the selection information is “folder path”, conversion target data that corresponds to “folder path” is acquired from the log management information. The conversion target data that corresponds to “folder path” is “C:¥Windows¥System¥sample.exe”, for example.

Also, when the conversion information is “registry key”, the conversion target data that corresponds to “registry key” is acquired from the log management information. The conversion target data that corresponds to “registry key” is “HKCU¥Software¥Microsoft¥Windows¥CurrentVersion¥Run”, for example.

Noise condition is information obtained by converting conversion target data based on a conversion method. For example, when the conversion target data is “C:¥Windows¥System32¥sample.exe” and the conversion method information indicates conversion for standardization of the folder path, the conversion target data is converted to “drive:¥windows¥system32¥sample.exe”.

Also, for example, when the conversion target data is “HKCU¥Software¥Microsoft¥Windows¥CurrentVersion¥Run” and the conversion method information indicates conversion for standardization of the registry key, the conversion target data is converted to “run”.

The noise information generation unit 13 generates noise information used for determining whether or not an observation is noise or not, in accordance with the noise condition generated for the log management information that corresponds to the predicate or the observation type. Specifically, if multiple noise conditions were generated from different selection information, the noise information is generated by connecting the noise conditions with a logical product (and).

For example, in the case of log management information that corresponds to the predicate or the observation type, if “drive:¥windows¥system32¥sample.exe” is generated as one noise condition from the folder path, “drive:¥windows¥system32¥sample.exe-h” is generated as another noise condition from the command line, and “drive:¥windows¥system32¥cmd.exe” is generated as another noise condition from the folder path of the parent process, then three noise conditions have been generated from different selection information, and the noise information is “drive:¥windows¥system32¥sample.exe” and “drive:¥windows¥system32¥sample.exe-h” and “drive:¥windows¥system32¥cmd.exe”.

Also, if multiple noise conditions were generated from the same selection information, the noise information is generated by connecting the noise conditions with a logical sum (or). For example, in the case of log management information that corresponds to the predicate or the observation type, if “run” is generated as one noise condition from one registry key, and “runonce” is generated as another noise condition from another registry key, then two noise conditions have been generated from the same selection information, and the noise information is “run” or “runonce”.

As described above, in this example embodiment, conversion information is defined for each type of attack, and noise information can be generated in accordance with a type of attack. Also, noise can be reduced by using noise information, thus making it possible to improve the work efficiency of an analyst who performs cyber attack analysis.

### [System Configuration]

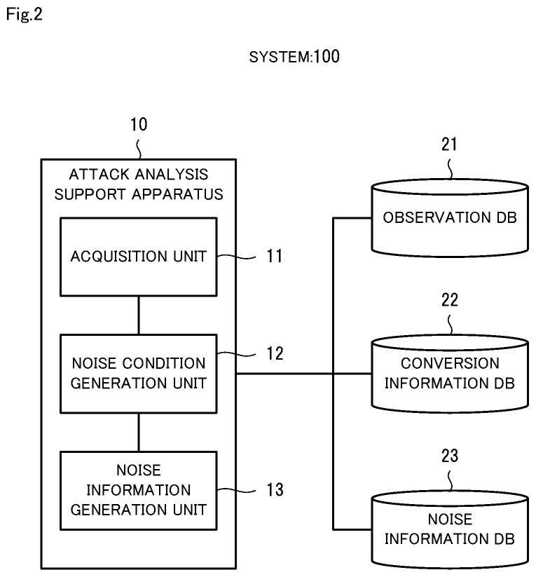

The configuration of the attack analysis support apparatus 10 will be described below in more detail with reference to FIG. 2. FIG. 2 is a diagram for describing an example of a system that includes the attack analysis support apparatus of the first example embodiment.

As shown in FIG. 2, a system 100 includes the attack analysis support apparatus 10 and a storage device (observation DB 21, conversion information DB 22, noise information DB 23).

The attack analysis support apparatus 10 includes an acquisition unit 11, a noise condition generation unit 12, and a noise information generation unit 13.

The attack analysis support apparatus 10 is an information processing device such as a circuit, a server computer, a personal computer, or a mobile terminal, which includes a central processing unit (CPU), a programmable device such as a field-programmable gate array (FPGA), a graphics processing unit (GPU), or a combination thereof.

In the example of FIG. 2, the storage device corresponds to the observation DB 21, the conversion information DB 22, the noise information DB 23, and the like. The observation DB 21, the conversion information DB 22, and the noise information DB 23 can be realized using a server computer, a database, or the like.

The observation DB 21, the conversion information DB 22, and the noise information DB 23 are described below in order to facilitate understanding of the description, but the information stored in these three databases may be stored in one or more databases.

The observation DB 21 is a database that manages observations and logs associated with the observations. The observation DB 21 stores observation information, observation management information, log management information, and observation type information.

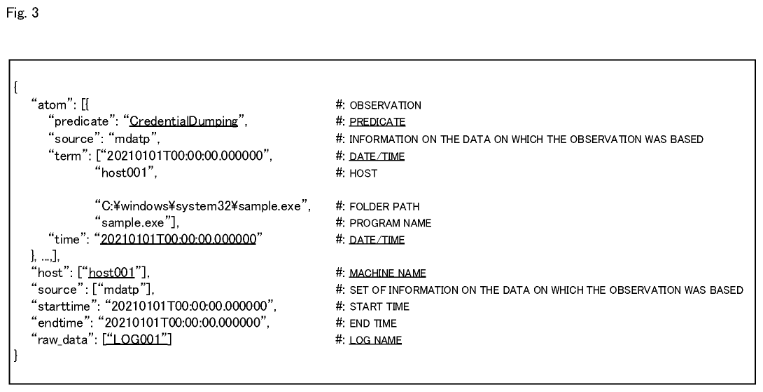

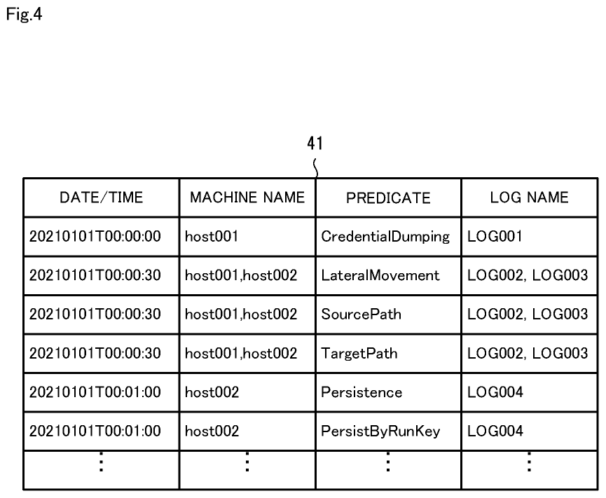

Observation information is information indicating an observation. Observation information will be described below with reference to FIGS. 3 and 4. FIG. 3 is a diagram for describing an example of an observation. FIG. 4 is a diagram for describing an example of observation information.

Observation information is information in which information indicating a date/time, information for identifying a machine (machine name), a predicate, and information for identifying a log (log name) are associated with each other, for example. For example, in the example of the observation shown in FIG. 3, as shown in the first row of a table 41 in FIG. 4, the observation information is information in which the predicate “CredentialDumping” is associated with the date/time “20210101T00:00:00”, the machine name “host001”, and the log name “LOG001”.

Observation management information is information in which predicates of observation information that can specify a type of attack based on a predetermined attack trace are associated with related machine names and log names.

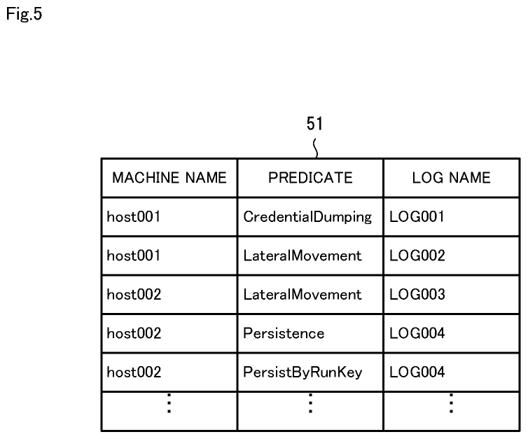

FIG. 5 is a diagram for describing an example of observation management information. A table 51 in FIG. 5 shows an example of observation management information including the predicates “CredentialDumping”, “LateralMovement”, “Persistence”, and “PersistBy RunKey”. The predicate “CredentialDumping” indicates the execution of a program that steals authentication information, the predicate “LateralMovement” indicates the execution of horizontal deployment between devices, the predicate “Persistence” indicates the raising of an alert that persistent execution was detected, and the predicate “PersistByRunKey” indicates persistent execution set using the Run key in the registry.

In the case of the table 51 in FIG. 5, the predicate “SourcePath” and the predicate “TargetPath” shown in the table 41 in FIG. 4 are traces of an attack, but are traces that do not enable specifying the type of attack, and thus are not stored in the table 51.

Log management information is information for managing logs that include a trace of an attack. The log management information includes information such as a log name, information indicating a date/time, a machine name, and one or more pieces of conversion target data that correspond to a predicate or an observation type, for each of a plurality of logs.

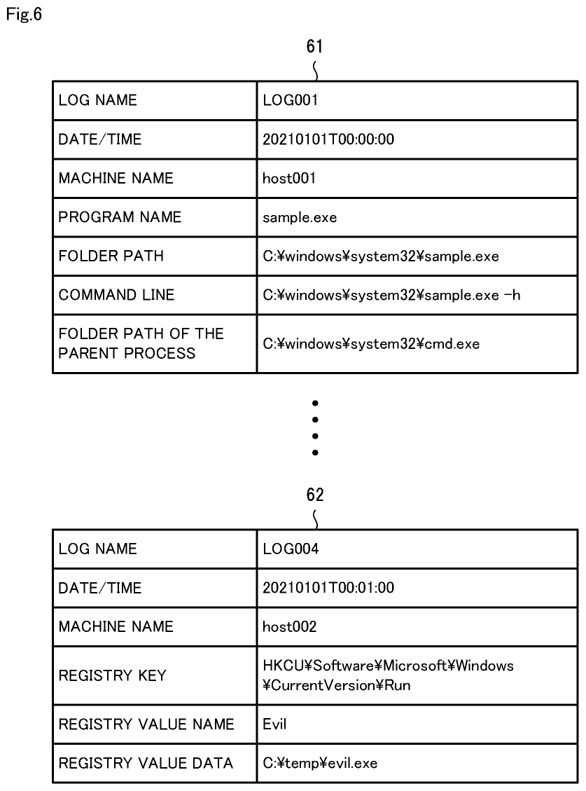

FIG. 6 is a diagram for describing an example of log management information. A table 61 in FIG. 6, which shows an example of log management information, is log management information in the case where the observation type is “process”. In the example in the table 61, the log name “LOG001”, the date/time “20210101T00:00:00”, the machine name “host001”, the program name “sample.exe”, and multiple pieces of conversion target data are associated with each other.

The conversion target data in the table 61 is the folder path “C:¥windows¥system32¥sample.exe”, the command line “C:¥windows¥system32¥sample.exe-h”, and the folder path of the parent process “C:¥windows¥system32¥cmd.exe”.

A table 62 is log management information in the case where the observation type is “persistence”. In the example of the table 62, the log name “LOG004”, the date/time “20210101T00:01:00”, the machine name “host002”, and multiple pieces of conversion target data are associated with each other.

The conversion target data in the table 62 is the registry key “HKCU¥Software¥Microsoft¥Windows¥CurrentVersion¥Run”, the registry value name “Evil”, and the registry value data “C:¥temp¥evil.exe”.

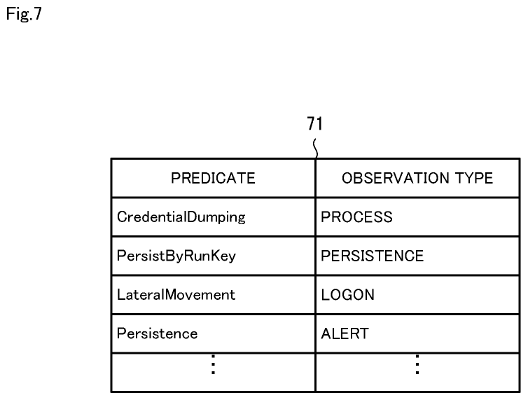

Observation type information is information in which predicates are associated with observation types. FIG. 7 is a diagram for describing an example of observation type information. In the example of a table 71 in FIG. 7, as described above, the predicate “CredentialDumping” is associated with the observation type “process”, and the predicate “PersistByRunKey” is associated with the observation type “persistence”. Also, the predicate “LateralMovement” is associated with the observation type “logon”, and the predicate “Persistence” is associated with the observation type “alert”.

The conversion information DB 22 is a database that manages different conversion information for each observation type. The conversion information DB 22 stores conversion information correspondence management information and conversion information management information.

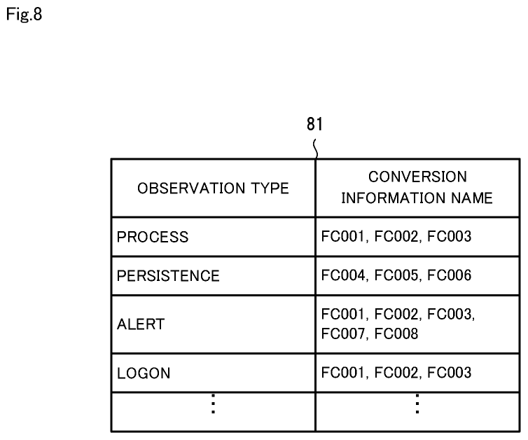

Conversion information correspondence management information is information in which observation types and conversion information are associated with each other. FIG. 8 is a diagram for describing an example of conversion information correspondence management information. In the example of a table 81 in FIG. 8, the observation type “process” is associated with the conversion information names “FC001, FC002, FC003” that identify conversion information, and the observation type “persistence” is associated with the conversion information names “FC004, FC005, FC006” that identify conversion information.

Also, the observation type “alert” is associated with the conversion information names “FC001, FC002, FC003, FC007, FC008” that identify conversion information, and the observation type “logon” is associated with the conversion information names “FC001. FC002, FC003” that identify conversion information.

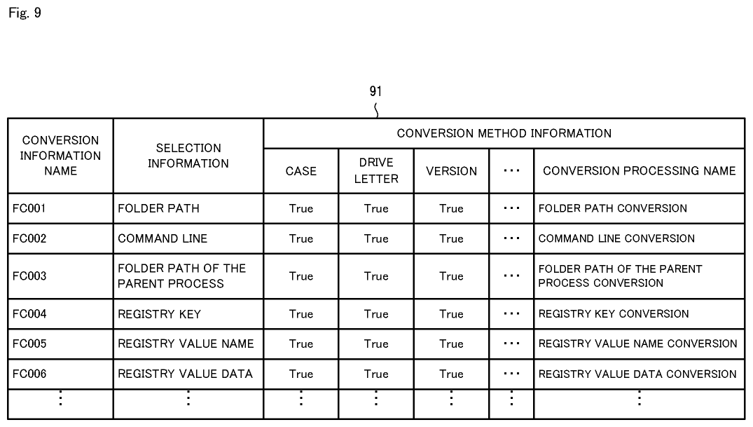

Conversion information management information is information that manages conversion information. FIG. 9 is a diagram for describing an example of conversion information management information. In the example of a table 91 in FIG. 9, a conversion information name, selection information for selecting conversion target data from log management information, and conversion method information for standardizing the selected conversion target data are associated with each other.

Also, in the example of the table 91 in FIG. 9, in the conversion method information, setting information (case, drive letter, version) indicating settings used in conversion processing for converting the selected conversion target data, and information (conversion processing name) identifying conversion processing are associated with each other.

In the conversion method information, “case” is information that determines whether or not uppercase characters included in the selected conversion target data are to be converted to lowercase characters. Also, “drive letter” is information that, when the selected conversion target data includes a drive letter, determines whether or not the drive letter is to be set to a standardized drive letter. Also, “version” is information that, when the selected conversion target data includes a version, determines whether or not the version name is to be set to standardized version name.

The conversion processing is processing for standardizing the selected conversion target data according to a predetermined procedure based on the settings in the setting information, and generating a noise condition. Programs used for the conversion processing are stored in a storage device such as the conversion information DB 22, for example.

In the case of the table 91 in FIG. 9, the conversion information name “FC001” in FIG. 9 is associated with the selection information “folder path” and the conversion processing name “folder path conversion”. In this case, the selected conversion target data is standardized using the settings in the setting information and folder path conversion, and a noise condition is generated.

If “case” in the setting information is set to “True”, when executing folder path conversion, processing is executed to convert uppercase characters included in the conversion target data to lowercase characters. If “case” is “False”, processing for converting uppercase characters to lowercase characters is not executed.

If the setting information “drive letter” is set to “True”, when executing folder path conversion, processing is executed to convert the drive letter included in the conversion target data to a standardized drive letter. If “drive Letter” is “False”, processing for converting the drive letter is not executed.

If “version” in the setting information is set to “True”, when executing folder path conversion, processing is executed to convert the version name included in the conversion target data into a standardized version name. If “version” is “False”, processing for converting the version name is not executed.

Note that the setting information is not limited to “case”, “drive letter”, and “version”, and other setting information may be provided.

The noise information DB 23 is a database that manages generated noise information. The noise information DB 23 stores noise condition management information and noise information management information.

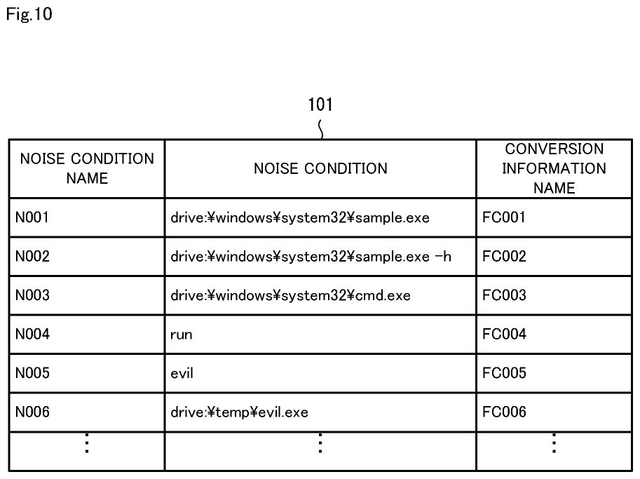

Noise condition management information is information for managing noise conditions for determining that an observation is noise. FIG. 10 is a diagram for describing an example of noise condition management information. In the information managed in the example of a table 101 in FIG. 10, information identifying a noise condition (noise condition name), noise conditions, and conversion information names are associated with each other.

For example, the table 101 in FIG. 10 shows noise conditions that correspond to the noise condition names “N001” to “N003” generated based on the log management information with the log name “LOG001”, and noise conditions that correspond to the noise condition names “N004” to “N006” generated based on the log management information with the log name “LOG004”.

The generated noise condition “drive:¥windows¥system32¥sample.exe” is stored in association with the noise condition name “N001” and the conversion information name “FC001”. The generated noise condition “drive:¥windows¥system32¥sample.exe-h” is stored in association with the noise condition name “N002” and the conversion information name “FC002”. The generated noise condition “drive:¥windows¥system32¥cmd.exe” is stored in association with the noise condition name “N003” and the conversion information name “FC003”.

The generated noise condition “run” is stored in association with the noise condition name “N004” and the conversion information name “FC004”. The generated noise condition “evil” is stored in association with the noise condition name “N005” and the conversion information name “FC005”. The generated noise condition “drive:¥temp¥evil.exe” is stored in association with the noise condition name “N006” and the conversion information name “FC006”.

Noise information management information is information for managing noise information for determining whether or not an observation is noise based on a noise condition. The noise information is expressed using a noise condition name based on the noise condition (based on a preset procedure (rule)).

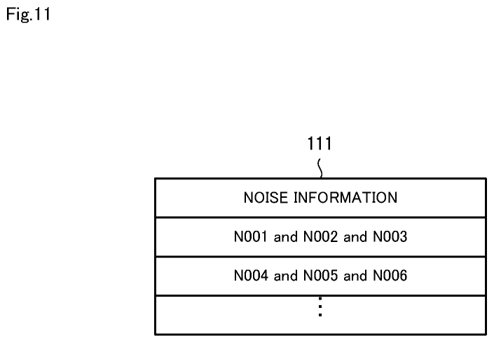

FIG. 11 is a diagram for describing an example of noise information management information. A table 111 in FIG. 11 shows noise information (“N001 and N002 and N003”) generated based on three noise conditions (noise conditions corresponding to the noise condition names “N001” to “N003”) generated based on the log management information with the log name “LOG001”, and noise information (“N004 and N005 and N006”) generated based on three noise conditions (noise conditions corresponding to the noise condition names “N004” to “N006”) generated based on the log management information with the log name “LOG004”.

Specifically, in the noise information “N001 and N002 and N003” and the noise information “N004 and N005 and N006” in the table 111 in FIG. 11, the noise conditions were generated based on different selection information related to log management information, as shown in the table 101 in FIG. 10, and therefore the noise information was generated based on the rule of connecting the noise conditions with a logical product (and).

Also, if the noise conditions were generated based on the same selection information related to log management information, the noise information is generated based on the rule of connecting the noise conditions with a logical sum (or). For example, if the noise conditions that correspond to the noise condition names “N00A”, “N00B”, and “N00C” were all generated from the same selection information, the noise information is “N00A or N00B or N00C”.

As another example, if the selection information of the noise condition that corresponds to the noise condition name “N00A” is different from the selection information of the noise conditions that correspond to the noise condition names “N00B” and “N00C”, and the selection information is the same for the noise conditions that correspond to the noise condition names “N00B” and “N00C”, then the noise information is “N00A and (N00B or N00C)”.

The following is a detailed description of the attack analysis support apparatus.

The acquisition unit 11 first refers to the observation management information stored in the observation DB 21 and acquires a predicate and a log name. For example, the acquisition unit 11 refers to the table 51 in FIG. 5 and acquires the predicate “CredentialDumping” and the log name “LOG001”.

Next, the acquisition unit 11 uses the log name acquired from the observation management information to acquire the piece of log management information that matches the acquired log name from the pieces of log management information stored in the observation DB 21. For example, the acquisition unit 11 acquires the table 61 in FIG. 6 that has the log name that matches the acquired log name “LOG001”.

Next, the acquisition unit 11 uses the predicate acquired from the observation management information to acquire the observation type that corresponds to the acquired predicate from the observation type information stored in the observation DB 21. For example, the acquisition unit 11 uses the acquired predicate “CredentialDumping” to refer to the table 71 in FIG. 7, and acquires the observation type “process” that corresponds to the acquired predicate.

The noise condition generation unit 12 first uses the acquired observation type to refer to the conversion information correspondence management information stored in the conversion information DB 22, and acquires a conversion information name. For example, the noise condition generation unit 12 uses the acquired observation type “process” to refer to the table 81 in FIG. 8, and acquires the conversion information names “FC001, FC002, FC003” that correspond to the acquired observation type.

Next, the noise condition generation unit 12 uses the acquired conversion information name to refer to the conversion information management information stored in the conversion information DB 22, and acquires conversion information (selection information and conversion method information). For example, the noise condition generation unit 12 uses the acquired conversion information names “FC001”, “FC002”, and “FC003” to refer to the table 91 in FIG. 9, and acquires the pieces of conversion information that respectively correspond to the conversion information names.

Next, the noise condition generation unit 12 uses selection information of the acquired conversion information to refer to the acquired log management information, and selects the conversion target data that matches the selection information from the log management information. For example, the noise condition generation unit 12 uses the selection information “folder path”, “command line”, and “folder path of parent process” respectively corresponding to the acquired conversion information names “FC001”, “FC002”, and “FC003” to acquire the conversion target data “C:¥windows¥system32¥sample.exe”, “C:¥windows¥system32¥sample.exe-h”, and “C:¥windows¥system32¥cmd.exe” that correspond to the selection information from the table 61 in FIG. 6.

Next, the noise condition generation unit 12 converts the selected conversion target data based on the conversion method information of the acquired conversion information, to generate a noise condition. For example, the noise condition generation unit 12 converts the acquired conversion target data “C:¥windows¥system32¥sample.exe”, “C:¥windows¥system32¥sample.exe-h”, and “C:¥windows¥system32¥cmd.exe” based on the conversion method information respectively corresponding to the acquired conversion information names “FC001”, “FC002”, and “FC003”, to generate the noise conditions “drive:¥windows¥system32¥sample.exe”, “drive:¥windows¥system32¥sample.exe-h”, and “drive:¥windows¥system32¥cmd.exe”.

Specifically, in the case of the conversion target data “C:¥windows¥system32¥sample.exe” that corresponds to the conversion information name “FC001”, through folder path conversion, uppercase characters are converted to lowercase characters, and the drive letter is standardized, thus generating the noise condition “drive:¥windows¥system32¥sample.exe”.

Next, the noise condition generation unit 12 stores the noise condition, information for identifying the noise condition (noise condition name), and the conversion information name in association with each other in the noise information DB 23. For example, the noise condition generation unit 12 stores the noise condition name, the noise condition, and the conversion information name in association with each other in the noise information DB 23, as shown in the table 101 in FIG. 10.

The noise information generation unit 13 generates noise information for determining whether or not an observation is noise, according to the noise condition generated for the log management information, and stores the generated noise information in the noise information DB 23.

For example, in the case of the table 101 in FIG. 10, the selection information is different for each of the noise conditions that correspond to the noise condition names “N001” to “N003” corresponding to the log name “LOG001”, and therefore the noise information generation unit 13 connects the noise condition names with a logical product (and) to generate the noise information “N001 and N002 and N003”.

Next, the noise information generation unit 13 stores the generated pieces of noise information “N001 and N002 and N003” and “N004 and N005 and N006” in the noise information DB 23, as shown in the table 111 of FIG. 11.

### [Apparatus Operations]

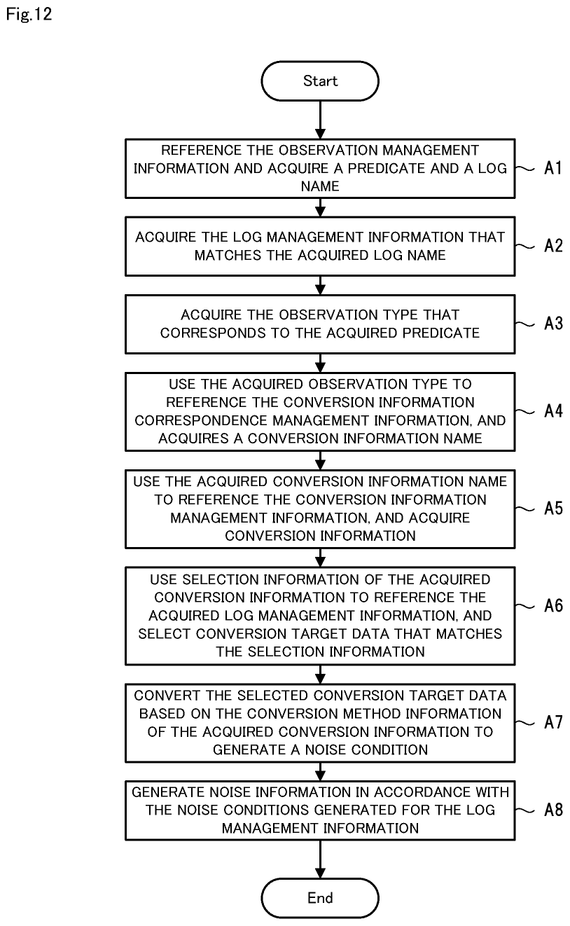

Operation of the attack analysis support apparatus 10 in the first example embodiment will be described below with reference to FIG. 12. FIG. 12 is a diagram for describing an example of operation of the attack analysis support apparatus according to the first example embodiment. The drawings will be referred to as appropriate in the following description. Also, in the first example embodiment, the attack analysis support method is implemented by causing the attack analysis support apparatus to operate. Therefore, the following description of operations of the attack analysis support apparatus will substitute for the description of the attack analysis support method in the first example embodiment.

The acquisition unit 11 first refers to the observation management information and acquires a predicate and a log name (step A1). Next, the acquisition unit 11 uses the log name acquired from the observation management information to acquire the piece of log management information that matches the acquired log name from the pieces of log management information (step A2). Next, the acquisition unit 11 uses the predicate acquired from the observation management information to acquire the observation type that corresponds to the acquired predicate from the observation type information (step A3).

Next, the noise condition generation unit 12 uses the acquired observation type to refer to the conversion information correspondence management information, and acquires a conversion information name (step A4). Next, the noise condition generation unit 12 uses the acquired conversion information name to refer to the conversion information management information, and acquires conversion information (selection information and conversion method information) (step A5). Next, the noise condition generation unit 12 uses selection information of the acquired conversion information to refer to the acquired log management information, and selects conversion target data that matches the selection information from the log management information (step A6).

Next, the noise condition generation unit 12 converts the selected conversion target data based on the conversion method information of the acquired conversion information to generate a noise condition (step A7), generates noise condition management information by associating the noise condition, information for identifying the noise condition (noise condition name), and the conversion information name with each other, and stores the generated noise condition management information in the noise information DB 23.

Next, the noise information generation unit 13 generates noise information for determining whether or not an observation is noise, in accordance with the noise conditions generated for respective pieces of log management information (step A8), and stores the generated noise information in the noise information DB 23.

Note that in the processing of steps A1 to A8 described above, all or some of the predicates in the observation management information are selected, and the processing is executed for each of the selected predicates.

### Effects of First Example Embodiment

According to the first example embodiment, conversion information is defined for each type of attack, and noise information can be generated in accordance with a type of attack. Also, noise can be reduced by using noise information, thus making it possible to improve the work efficiency of an analyst who performs cyber attack analysis.

### [Program]

The program according to the first example embodiment may be a program that causes a computer to execute steps A1 to A8 shown in FIG. 12. By installing this program in a computer and executing the program, the attack analysis support apparatus and the attack analysis support method according to the example embodiment can be realized. In this case, the processor of the computer performs processing to function as the acquisition unit 11, the noise condition generation unit 12, and the noise information generation unit 13.

Also, the program according to the first example embodiment may be executed by a computer system constructed by a plurality of computers. In this case, for example, each computer may function as any of the acquisition unit 11, the noise condition generation unit 12, and the noise information generation unit 13.

### First Example Modification

In a first example modification, the accuracy of noise information can be improved by further narrowing down the noise information generated in the first example embodiment.

### [System Configuration]

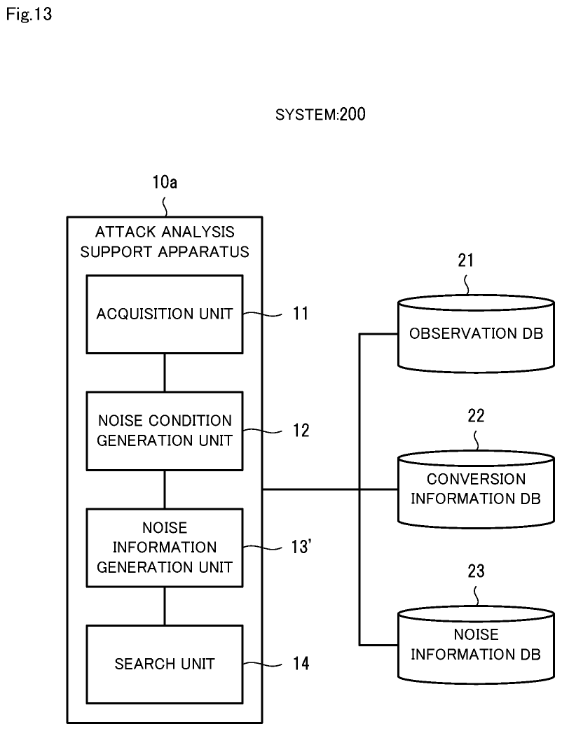

FIG. 13 is a diagram for describing an example of a system including an attack analysis support apparatus of the first example modification. A system 200 includes an attack analysis support apparatus 10a and a storage device (observation DB 21, conversion information DB 22, noise information DB 23).

The attack analysis support apparatus 10a includes the acquisition unit 11, the noise condition generation unit 12, a noise information generation unit 13, and a search unit 14. Note that the acquisition unit 11 and the noise condition generation unit 12 have already been described, and thus a description of the acquisition unit 11 and the noise condition generation unit 12 will be omitted.

The noise information generation unit 13′ generates provisional noise information using a noise condition in the same manner as operations of the noise information generation unit 13.

The search unit 14 uses a preset search condition to search for noise information that matches the search condition from the noise information generated by the noise information generation unit 13′.

Specifically, the search unit 14 may conceivably perform a search using the following search conditions (1) to (3). The search unit 14 performs a search using (1) a specific character string. (2) multiple machine names, and (3) noise information as search conditions. It is assumed that the search conditions are input by the user with use of an input device (not shown) or are set in advance.

(1) The search unit 14 searches for noise information based on a specific character string, and stores the found noise information in the noise information DB 23. A search for noise information using a specific character string is performed based on whether or not a character string included in the noise condition of the noise information matches the specific character string. For example, if the specific character string is “sample.exe”, only noise information in which the noise condition includes “sample.exe” is stored in the noise information DB 23.

By searching for noise information using a specific character string as mentioned above (e.g., by performing a search using a Windows Update execution file name or performing a search using an anti-virus software execution file name), it is possible for only noise information generated by the operation of an execution file that can possibly be a cause of noise to be stored in the noise information DB 23.

(2) The search unit 14 searches for noise information that is the same in a plurality of machines, and stores the found noise information in the noise information DB 23. For example, in the case of performing a search for the same noise information in two machines, if there is noise information that includes the machine name “host001” and the noise condition “c:¥windows¥system32¥sample.exe”, and there is also noise information that includes the noise condition “c:¥windows¥system32¥sample.exe” and the machine name “host002”, then there is noise information that is the same for the two machine names “host001” and “host002”, and thus that noise information is registered in the noise information DB 23.

By searching for noise information that is the same in a plurality of machines, operations that are thought to be the same in a plurality of machines, such as Windows Update operations or anti-virus software operations, can be registered as noise in noise information, and it is possible for only noise information that is more likely to be noise to be registered in the noise information DB 23.

(3) The search unit 14 searches, based on the noise information, for noise information in which multiple pieces of the same noise information exist from the provisional noise information generated by the noise information generation unit 13′, deems the found noise information to be regular noise information, and stores the found noise information in the noise information DB 23.

If there are multiple pieces of the same noise information, it is highly likely that the noise is a regularly executed operation, and therefore noise information generated from a regular operation can be registered in the noise information DB 23.

### [Apparatus Operations]

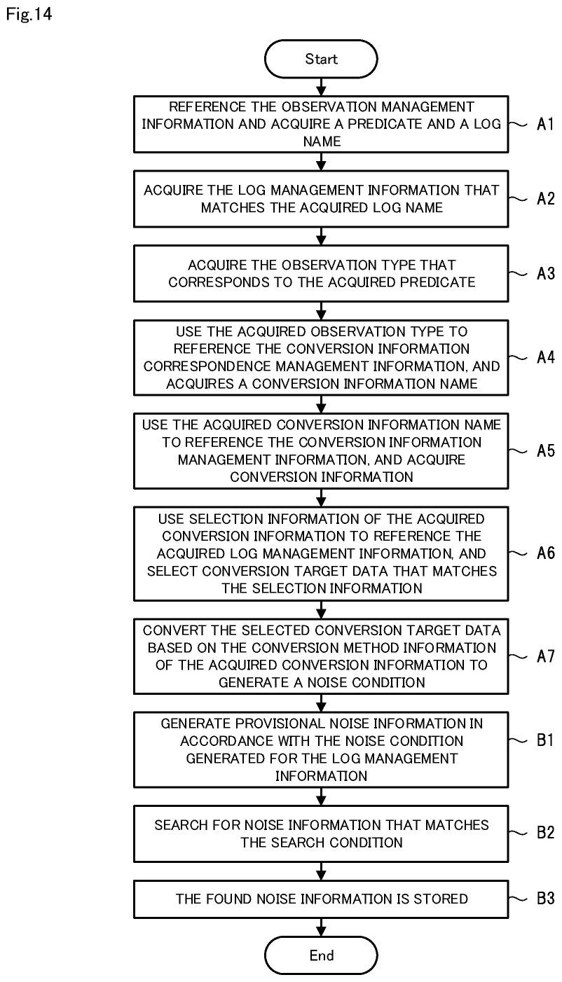

The following describes operations of the attack analysis support apparatus 10a in the first example modification with reference to FIG. 14. FIG. 14 is a diagram for describing an example of operations of the attack analysis support apparatus in the first example modification. The drawings will be referred to as appropriate in the following description. Furthermore, in the first example modification, an attack analysis support method is implemented by causing the attack analysis support apparatus to operate. Therefore, the following description of operations of the attack analysis support apparatus will substitute for the description of the attack analysis support method in the first example modification.

Steps A1 to A7 in FIG. 14 have already been described, and thus a description of steps A1 to A7 will be omitted.

The noise information generation unit 13 generates provisional noise information for determining whether or not the observation is noise, in accordance with the noise condition generated for the log management information, and stores the generated provisional noise information in the noise information DB 23 (step B1).

Note that in the processing of steps A1 to A7 and B1 described above, all or some of the predicates in the observation management information are selected, and the processing is executed for each of the selected predicates.

After the processing of steps A1 to A7 and B1 ends, the search unit 14 uses a preset search condition to search for noise information that matches the search condition from the provisional noise information generated by the noise information generation unit 13 (step B2). If noise information that matches the search condition is found, the found noise information is stored in the noise information DB 23 as regular noise information (step B3).

### Effects of First Example Modification

According to the first example modification, the accuracy of the noise information is improved by further narrowing down the noise information generated in the first example embodiment.

### [Program]

The program according to the first example modification may be a program that causes a computer to execute steps A1 to A7, B1 to B3 shown in FIG. 14. By installing this program in a computer and executing the program, the attack analysis support apparatus and the attack analysis support method according to the example embodiment can be realized. In this case, the processor of the computer performs processing to function as the acquisition unit 11, the noise condition generation unit 12, the noise information generation unit 13′, and the search unit 14.

Also, the program according to the first example modification may be executed by a computer system constructed by a plurality of computers. In this case, for example, each computer may function as any of the acquisition unit 11, the noise condition generation unit 12, the noise information generation unit 13′, and the search unit 14.

### Second Example Embodiment

The attack analysis support apparatus shown in a second example embodiment compares observations with noise information and deletes observations determined to be noise.

### [System Configuration]

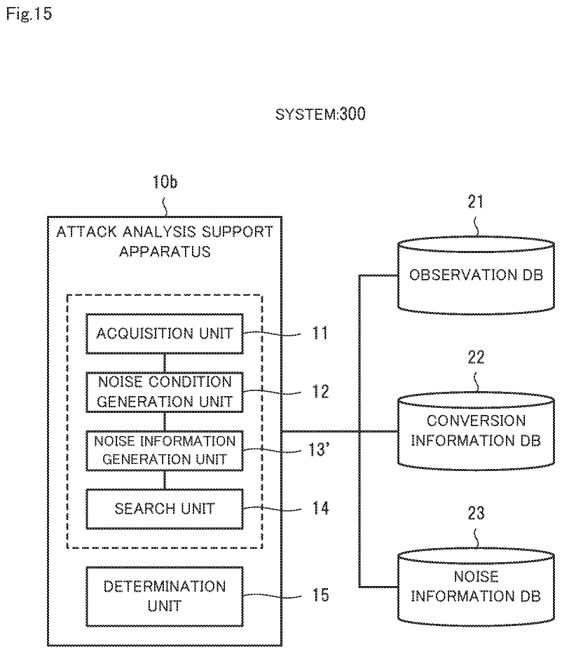

FIG. 15 is a diagram for describing an example of a system that includes the attack analysis support apparatus of the second example embodiment. A system 300 includes an attack analysis support apparatus 10b and a storage device (observation DB 21, conversion information DB 22, noise information DB 23).

The attack analysis support apparatus 10b includes the acquisition unit 11, the noise condition generation unit 12, the noise information generation unit 13′, the search unit 14, and a determination unit 15.

Although FIG. 15 shows the case where the attack analysis support apparatus 10b includes the acquisition unit 11, the noise condition generation unit 12, the noise information generation unit 13′, the search unit 14, and the determination unit 15, alternatively; the attack analysis support apparatus 10b may include the acquisition unit 11, the noise condition generation unit 12, the noise information generation unit 13′, and the determination unit 15. As another alternative, the attack analysis support apparatus 10b may include only the determination unit 15.

Note that the acquisition unit 11, the noise condition generation unit 12, the noise information generation unit 13′, and the search unit 14 have already been described, and thus descriptions will not be given for the acquisition unit 11, the noise condition generation unit 12, the noise information generation unit 13′, and the search unit 14.

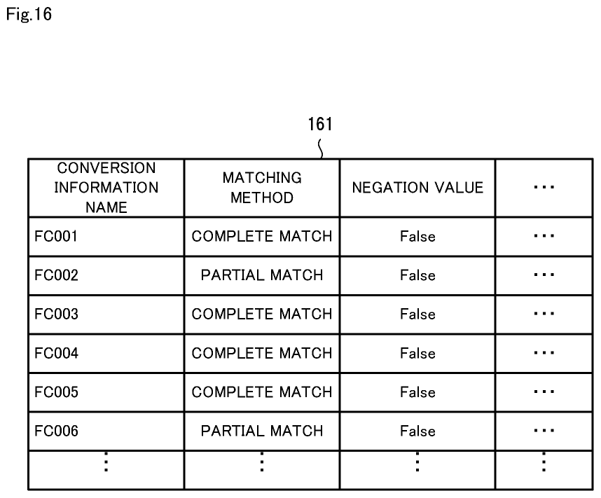

The noise information DB 23 stores noise determination information. The noise determination information manages information in which a conversion information name is associated with determination information (e.g., matching method, and negation value). FIG. 16 shows information for describing an example of noise determination information.

In a table 161 in FIG. 16, conversion information names, matching methods, and negation values are associated with each other. The determination information matching method is information indicating “complete match” or “partial match”. The negation value is information that negates the determination result.

The determination unit 15 determines whether or not an observation is noise using the noise information, and if the observation is noise, deletes the observation determined to be noise from the storage device.

Specifically, first, the determination unit 15 refers to the observation management information stored in the observation DB 21 and acquires a predicate and a log name that are determination targets. In this example, it is assumed that the acquisition unit 11 has referred to the table 51 in FIG. 5 and acquired the predicate “CredentialDumping” and the log name “LOG001” as determination targets.

Next, the determination unit 15 uses the log name acquired from the observation management information to acquire log management information that matches the acquired log name from the pieces of log management information stored in the observation DB 21. For example, the acquisition unit 11 acquires the table 61 in FIG. 6 that has the log name that matches the acquired log name “LOG001”.

Next, the determination unit 15 refers to the noise information management information stored in the noise information DB 23 and acquires noise information. For example, the determination unit 15 acquires the noise information “N001 and N002 and N003” from the table 111 in FIG. 11.

Next, the determination unit 15 uses the noise condition names of the acquired noise information to refer to the noise condition management information stored in the noise information DB 23, and acquires conversion information names. For example, the determination unit 15 uses the noise conditions “N001”, “N002”, and “N003” to refer to the table 101 in FIG. 10, and acquires the conversion information names “FC001”, “FC002”, and “FC003”.

Next, the determination unit 15 uses the acquired conversion information names to refer to the conversion information management information stored in the conversion information DB 22, and acquires conversion information. For example, the determination unit 15 uses the conversion information names “FC001”, “FC002”, and “FC003” to refer to the table 91 in FIG. 9, and acquires conversion information that corresponds to the conversion information names “FC001”, “FC002”, “FC003”.

Next, the determination unit 15 uses selection information of the acquired conversion information to refer to the log management information, and selects conversion target data that corresponds to the selection information from the log management information.

For example, the determination unit 15 uses the pieces of selection information “folder path”, “command line”, and “folder path of parent process” that correspond to the conversion information names “FC001”, “FC002”, and “FC003” in the table 91 of FIG. 9 to refer to the table 61 in FIG. 6, and selects the conversion information that corresponds to “C:¥windows¥system32¥sample.exe”, “C:¥windows¥system32¥sample.exe-h”, and “C:¥windows¥system32¥cmd.exe” that respectively correspond to the pieces of selection information.

Next, the determination unit 15 converts the selected conversion target data based on the conversion method information of the acquired conversion information. For example, based on the conversion method information of the acquired conversion information names “FC001”, “FC002”, and “FC003”, the determination unit 15 converts the acquired conversion target data “C:¥windows¥system32¥sample.exe”, “C:¥windows¥system32¥sample.exe-h”, and “C:¥windows¥system32¥cmd.exe”, into “drive:¥windows¥system32¥sample.exe”, “drive:¥windows¥system32¥sample.exe-h”, and “drive:¥windows¥system32¥cmd.exe”.

Next, the determination unit 15 compares the converted information and the noise condition of the noise condition management information using the noise determination information, and determines whether or not the converted information is noise based on the comparison result.

For example, in the case where the converted information is “drive:¥windows¥system32¥sample.exe”, the conversion information name that corresponds to the converted information is “FC001”, and thus the determination unit 15 acquires, from the table 101 in FIG. 10, the noise condition “drive:¥windows¥system32¥sample.exe” that corresponds to the noise condition name “N001” associated with the conversion information name “FC001”.

Then, the determination unit 15 uses the matching method “complete match” and the negation value “False”, which are the determination information associated with the conversion information name “FC001” in the table 16 of FIG. 16, to compare the converted information with the noise condition that corresponds to the noise condition name “N001”.

The converted information “drive:¥windows¥system32¥sample.exe” and the noise condition “drive:¥windows¥system32¥sample.exe” that corresponds to the noise condition name “N001” are a complete match, and thus the comparison result is “True”. Furthermore, since the negation value is “False”, the comparison result remains “True”. Note that if the negation value is “True”, the comparison result is set to “False”.

Note that the other pieces of converted information “drive:¥windows¥system32¥sample.exe-h” and “drive:¥windows¥system32¥cmd.exe” are also compared with the noise conditions “N002” and “N003” that correspond to the noise condition names. As a result, the noise condition names “N001”, “N002”, and “N003” all have a comparison result of “True”.

Next, the determination unit 15 applies the logic of the noise condition to the noise information to determine whether or not the observation is noise. Since the acquired noise information is “N001 and N002 and N003”, when the comparison result is substituted into the noise information, the result “True and True and True” is obtained, and the determination result is “True”. In other words, if all the noise conditions are true, the observation is determined to be noise.

Note that in the case where the noise information is “N00A or N00B or N00C”, if any of the noise conditions is “True”, the observation is determined to be noise. Furthermore, in the case of “N00A and (N00B or N00C)”, if N00A is “True” and “N00B” or “N00C” is “True”, the observation is determined to be noise.

Next, the determination unit 15 deletes the log management information from the observation DB 21 based on the determination result. For example, if the determination result is “True”, the table 61 in FIG. 6 is deleted from the observation DB 21. If the determination result is “False”, the log management information is not deleted from the observation DB 21.

### [Apparatus Operations]

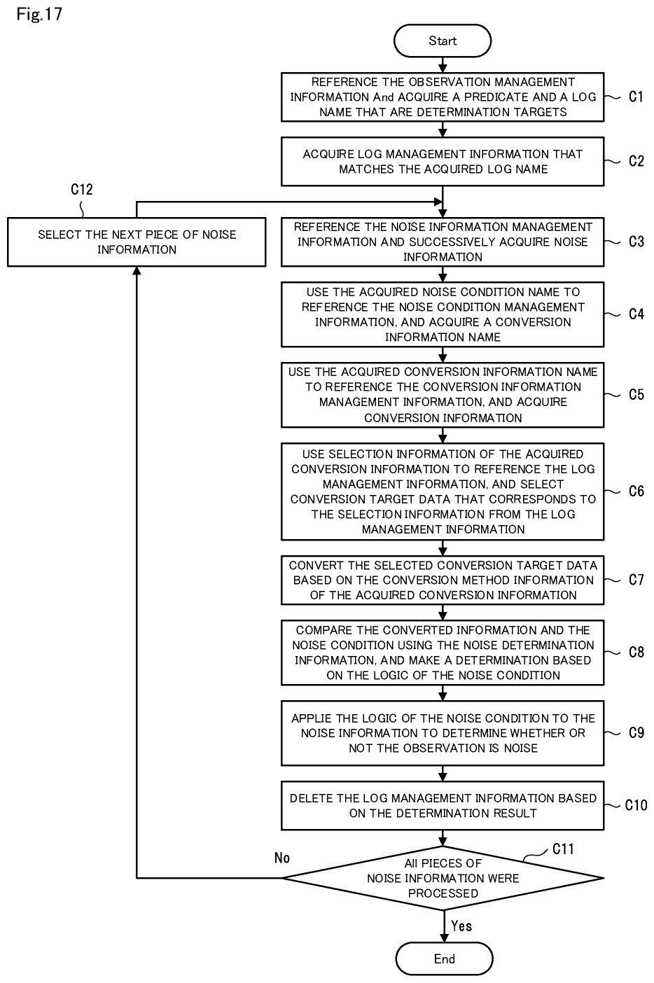

The following describes operation of the attack analysis support apparatus 10b in the second example embodiment with reference to FIG. 17. FIG. 17 is a diagram for describing an example of operation of the attack analysis support apparatus of the second example embodiment. The drawings will be referred to as appropriate in the following description. Also, in the second example embodiment, the attack analysis support method is implemented by causing the attack analysis support apparatus to operate. Therefore, the following description of the operation of the attack analysis support apparatus will substitute for the description of the attack analysis support method in the second example embodiment.

The determination unit 15 first refers to the observation management information and acquires a predicate and a log name that are determination targets (step C1). Next, the determination unit 15 uses the log name acquired from the observation management information to acquire log management information that matches the acquired log name from the pieces of log management information (step C2).

Next, the determination unit 15 refers to the noise information management information and successively acquires noise information (step C3). Next, the determination unit 15 uses the noise condition name of the acquired noise information to refer to the noise condition management information, and acquires a conversion information name (step C4).

Next, the determination unit 15 uses the acquired conversion information name to refer to the conversion information management information, and acquires conversion information (step C5). Next, the determination unit 15 uses selection information of the acquired conversion information to refer to the log management information, and selects conversion target data that corresponds to the selection information from the log management information (step C6).

Next, the determination unit 15 converts the selected conversion target data based on the conversion method information of the acquired conversion information (step C7). Next, the determination unit 15 compares the converted information and the noise condition of the noise condition management information using the noise determination information, and makes a determination based on the logic of the noise condition (step C8).

Next, the determination unit 15 applies the logic of the noise condition to the noise information to determine whether or not the observation is noise (step C9). Next, the determination unit 15 deletes the log management information based on the determination result (step C10).

Next, if the processing of steps C3 to C10 has been executed for all pieces of noise information in the noise condition management information (step C11: Yes), the determination unit 15 ends the determination processing. If there is noise information that has not been subjected to the processing of steps C3 to C10 (step C11: No), the determination unit 15 selects the next piece of noise information (step C12), and executes the processing of steps C3 to C10 on the selected piece of noise information.

Note that in the case where all or some of the predicates of the observation management information are selected, and the determination processing is executed for each of the selected predicates, the processing of steps C1 to C12 is executed for each of the selected predicates.

### [Effects of Second Example Embodiment]

According to the second example embodiment, noise can be reduced by using noise information generated in accordance with a type of attack. As a result, the work efficiency of an analyst who performs cyber attack analysis can be improved.

### [Program]

The program according to the second example embodiment may be a program that causes a computer to execute steps C1 to C12 shown in FIG. 17. By installing this program in a computer and executing the program, the attack analysis support apparatus and the attack analysis support method according to the first example embodiment can be realized. In this case, the processor of the computer performs processing to function as the acquisition unit 11, the noise condition generation unit 12, the noise information generation unit 13′, the search unit 14, and the determination unit 15. Or the processor of the computer performs processing to function as the acquisition unit 11, the noise condition generation unit 12, the noise information generation unit 13′, the search unit 14, and the determination unit 15. Or the processor of the computer performs processing to function as the determination unit 15.

Also, the program according to the first example modification may be executed by a computer system constructed by a plurality of computers. In this case, for example, each computer may function as any of the acquisition unit 11, the noise condition generation unit 12, the noise information generation unit 13′, the search unit 14, and the determination unit 15. Or each computer may function as any of the acquisition unit 11, the noise condition generation unit 12, the noise information generation unit 13′, the search unit 14, and the determination unit 15. Or each computer may function as any of the determination unit 15.

### Third Example Embodiment

An attack analysis support apparatus illustrated in a third example embodiment is the same as the attack analysis support apparatus of the second example embodiment, with the addition of a function for modifying conversion information and a function for displaying information regarding noise information, a noise condition, a noise determination result, and the like.

### [System Configuration]

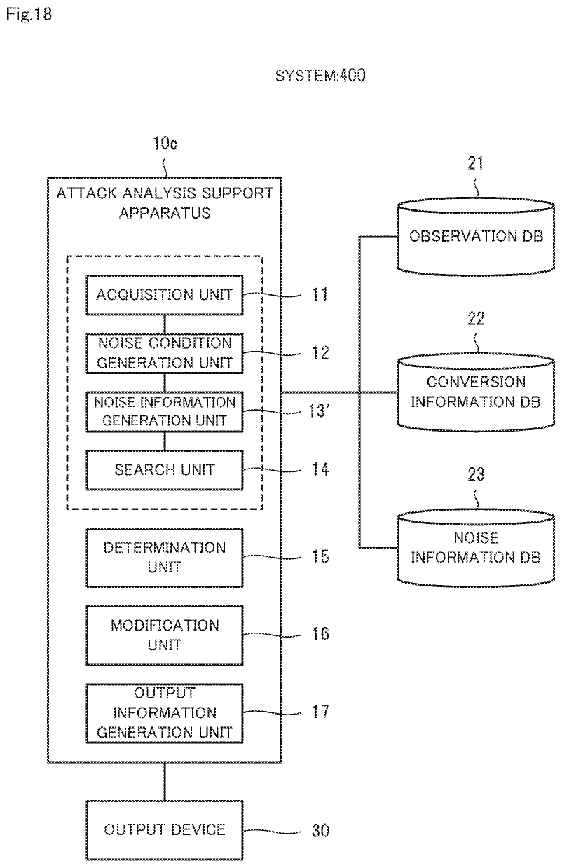

FIG. 18 is a diagram for describing an example of a system that includes the attack analysis support apparatus of the third example embodiment. A system 400 includes an attack analysis support apparatus 10c, a storage device (observation DB 21, conversion information DB 22, noise information DB 23), and an output device 30.

The attack analysis support apparatus 10c includes the acquisition unit 11, the noise condition generation unit 12, the noise information generation unit 13′, the search unit 14, the determination unit 15, a modification unit 16, and an output information generation unit 17.

Although FIG. 18 shows the case where the attack analysis support apparatus 10c includes the acquisition unit 11, the noise condition generation unit 12, the noise information generation unit 13′, the search unit 14, the determination unit 15, the modification unit 16, and the output information generation unit 17, alternatively, the attack analysis support apparatus 10c may include the acquisition unit 11, the noise condition generation unit 12, the noise information generation unit 13′, the determination unit 15, the modification unit 16, and the output information generation unit 17. As another alternative, the attack analysis support apparatus 10b may include the determination unit 15, the modification unit 16, and the output information generation unit 17.

Note that the acquisition unit 11, the noise condition generation unit 12, the noise information generation unit 13′, the search unit 14, and the determination unit 15 have already been described, and thus descriptions will not be given for the acquisition unit 11, the noise condition generation unit 12, the noise information generation unit 13′, the search unit 14, and the determination unit 15.

The modification unit 16 acquires modification information, which is for modifying conversion information and was generated by the user based on the noise information, and modifies conversion information based on the acquired modification information. Specifically, the modification unit 16 first acquires modification information from an input device (not shown). Next, the modification unit 16 modifies conversion information of the conversion information management information based on the acquired modification information. For example, the conversion method information in the table 91 in FIG. 9 is modified based on the modification information.

The output information generation unit 17 generates output information for outputting the generated noise information to an output device. Specifically, the output information generation unit 17 generates information regarding noise information, a noise condition, a noise determination result, the number of deleted observations, modification content, and the like, and outputs the generated information to the output device 30.

The output device 30 acquires later-described output information that has been converted into an output table format by the output information generation unit 17, and outputs a generated image, audio, or the like based on the output information. The output device 30 is an image display device using a liquid crystal display, an organic EL (Electro Luminescence) display, or a CRT (Cathode Ray Tube) display, for example. Furthermore, the image display device may include, for example, an audio output device such as a speaker. Note that the output device 30 may be a printing device such as a printer.

### Effects of Third Example Embodiment

According to this example embodiment, conversion information generated based on noise information can be modified, and thus the accuracy of the noise information can be improved. Furthermore, since the accuracy of noise information can be improved, the work efficiency of an analyst who performs cyber attack analysis can be improved.

### [Physical Configuration]

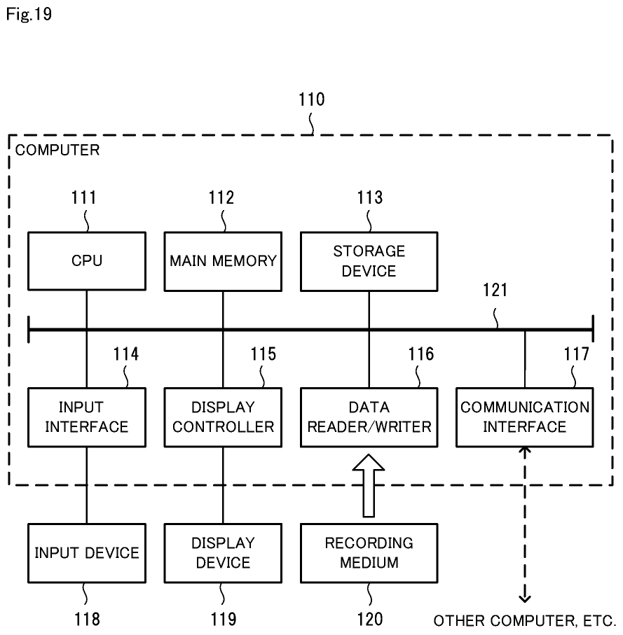

Here, a computer that realizes an attack analysis support apparatus by executing the program according to the first example embodiment, the first example modification, the second example embodiment and the third example embodiment will be described with reference to FIG. 19. FIG. 19 is a diagram for showing an example of a computer that realizes the attack analysis support apparatus in the first example embodiment, the first example modification, the second example embodiment and the third example embodiment.

As shown in FIG. 19, a computer 190 includes a CPU (Central Processing Unit) 191, a main memory 192, a storage device 193, an input interface 194, a display controller 195, a data reader/writer 196, and a communications interface 197. These units are each connected so as to be capable of performing data communications with each other through a bus 211. Note that the computer 190 may include a GPU or an FPGA in addition to the CPU 191 or in place of the CPU 191.

The CPU 191 opens the program (code) according to this example embodiment, which has been stored in the storage device 193, in the main memory 192 and performs various operations by executing the program in a predetermined order. The main memory 192 is typically a volatile storage device such as a DRAM (Dynamic Random Access Memory). Also, the program according to this example embodiment is provided in a state being stored in a computer-readable recording medium 210. Note that the program according to this example embodiment may be distributed on the Internet, which is connected through the communications interface 197. Note that the recording medium 210 is a non-volatile recording medium.

Also, other than a hard disk drive, a semiconductor storage device such as a flash memory can be given as a specific example of the storage device 193. The input interface 194 mediates data transmission between the CPU 191 and an input device 198, which may be a keyboard or mouse. The display controller 195 is connected to a display device 199, and controls display on the display device 199.

The data reader/writer 196 mediates data transmission between the CPU 191 and the recording medium 210, and executes reading of a program from the recording medium 210 and writing of processing results in the computer 190 to the recording medium 210. The communications interface 197 mediates data transmission between the CPU 191 and other computers.

Also, general-purpose semiconductor storage devices such as CF (Compact Flash (registered trademark)) and SD (Secure Digital), a magnetic recording medium such as a Flexible Disk, or an optical recording medium such as a CD-ROM (Compact Disk Read-Only Memory) can be given as specific examples of the recording medium 210.

Also, instead of a computer in which a program is installed, the attack analysis support apparatus according to above example embodiments can also be realized by using hardware corresponding to each unit. Furthermore, a portion of the attack analysis support apparatus may be realized by a program, and the remaining portion realized by hardware.

### Supplementary Note

Furthermore, the following supplementary notes are disclosed regarding the example embodiments described above. Some portion or all the example embodiments described above can be realized according to (supplementary note 1) to (supplementary note 12) described below, but the below description does not limit.

### (Supplementary Note 1)

An attack analysis support apparatus comprising:
an acquiring unit that acquires a predicate indicating a type of an attack included in an observation indicating a trace of the attack, or an observation type indicating a type of the observation corresponding to the predicate;
a noise condition generating unit that generates a noise condition by, with use of selection information that is included in conversion information associated with the predicate or the observation type and is for selecting conversion target data included in log management information for managing a log, selecting conversion target data from the log management information, and converts the selected conversion target data based on conversion method information included in the conversion information; and
a noise information generating unit that generates noise information to be used for determination of whether or not the observation is noise, in accordance with the noise condition generated for the log management information.

### (Supplementary Note 2)

The attack analysis support apparatus according to supplementary note 1, further comprising:
a searching unit that searches, with use of a search condition that was set in advance and is for searching for noise, for noise information that matches the search condition, from the noise information generated by the noise information generating means.

### (Supplementary Note 3)

The attack analysis support apparatus according to supplementary note 1 or 2, further comprising:
a determining unit that determines whether or not the observation is noise with use of the noise information, and deleting the observation from the storage device in a case of determining that the observation is noise.

### (Supplementary Note 4)

The attack analysis support apparatus according to any one of supplementary notes 1 to 3, further comprising:
an output information generating unit that generates output information for outputting the generated noise information to an output device; and
a modifying unit that acquires modification information, which is for modifying the conversion information and was generated by a user based on the noise information, and modifying the conversion information based on the acquired modification information.
   (Supplementary note 5)

An attack analysis support method comprising:
an acquiring step of acquiring a predicate indicating a type of an attack included in an observation indicating a trace of the attack, or an observation type indicating a type of the observation corresponding to the predicate;
a noise condition generating step of generating a noise condition by, with use of selection information that is included in conversion information associated with the predicate or the observation type and is for selecting conversion target data included in log management information for managing a log, selecting conversion target data from the log management information, and converting the selected conversion target data based on conversion method information included in the conversion information; and
a noise information generating step of generating noise information to be used for determination of whether or not the observation is noise, in accordance with the noise condition generated for the log management information.
   (Supplementary note 6)

The attack analysis support method according to supplementary note 5, wherein:
a searching step of searching, with use of a search condition that was set in advance and is for searching for noise, for noise information that matches the search condition, from the generated noise information.
   (Supplementary note 7)

The attack analysis support method according to supplementary note 5 or 6, wherein:
a determining step of determining whether or not the observation is noise with use of the noise information, and deletes the observation from the storage device in a case of determining that the observation is noise.
   (Supplementary note 8)

The attack analysis support method according to any one of supplementary notes 5 to 7, wherein:
an output information generating step of generating output information for outputting the generated noise information to an output device; and
a modifying step of acquiring modification information, which is for modifying the conversion information and was generated by a user based on the noise information, and modifying the conversion information based on the acquired modification information.
   (Supplementary note 9)

A computer-readable recording medium that includes a program recorded thereon, the program including instructions that causes a computer to carry out the steps of:
an acquiring step of acquiring a predicate indicating a type of an attack included in an observation indicating a trace of the attack, or an observation type indicating a type of the observation corresponding to the predicate;
a noise condition generating step of generating a noise condition by, with use of selection information that is included in conversion information associated with the predicate or the observation type and is for selecting conversion target data included in log management information for managing a log, selecting conversion target data from the log management information, and converting the selected conversion target data based on conversion method information included in the conversion information; and
a noise information generating step of generating noise information to be used for determination of whether or not the observation is noise, in accordance with the noise condition generated for the log management information.
   (Supplementary note 10)

The computer-readable recording medium according to claim 9,
wherein the program causes the computer to carry out the step of:
a searching step of searching, with use of a search condition that was set in advance and is for searching for noise, for noise information that matches the search condition, from the generated noise information.
   (Supplementary note 11)

The computer-readable recording medium according to claim 9 or 10,
wherein the program causes the computer to carry out the step of:
a determining step of determining whether or not the observation is noise with use of the noise information, and deleting the observation from the storage device in a case of determining that the observation is noise.
   (Supplementary note 12)

The computer-readable recording medium according to any one of claims 9 to 11,
wherein the program causes the computer to carry out the steps of:
an output information generating step of generating output information for outputting the generated noise information to an output device; and
a modifying step of acquiring modification information, which is for modifying the conversion information and was generated by a user based on the noise information, and modifying the conversion information based on the acquired modification information.

Although the present invention has been described above with reference to the example embodiment, the present invention is not limited to the above example embodiment. Various changes that can be understood by those skilled in the art can be made within the scope of the present invention in terms of the structure and details of the present invention.

### INDUSTRIAL APPLICABILITY

As described above, according to the present invention, it is possible to generate information for reducing noise according to the type of attack. The present invention is useful in fields in which analysis of cyber attack is required.

### LIST OF REFERENCE SIGNS

10, 10a, 10b, 10c Attack analysis support apparatus
11 Acquisition unit
12 Noise condition generation unit
13, 13′ Noise information generation unit
14 Search unit
15 Determination unit
16 Modification unit
17 Output information generation unit
21 Observation DB
22 Conversion information DB
23 Noise information DB
30 Output device
100, 200, 300, 400 System
190 Computer
191 CPU
192 Main memory
193 Storage device
194 Input interface
195 Display controller
196 Data reader/writer
197 Communication interface
198 Input device
199 Display device
210 Recording medium
211 Bus

What is claimed is:

1. An attack analysis support apparatus comprising:
one or more memories storing instructions; and
one or more processors configured to execute the instructions to:
an acquiring means for acquiring acquire a predicate indicating a type of an attack included in an observation indicating a trace of the attack, or an observation type indicating a type of the observation corresponding to the predicate;
generate a noise condition by, with use of selection information that is included in conversion information associated with the predicate or the observation type and is for selecting conversion target data included in log management information for managing a log, selecting conversion target data from the log management information, and converting the selected conversion target data based on conversion method information included in the conversion information; and
generate noise information to be used for determination of whether or not the observation is noise, in accordance with the noise condition generated for the log management information.

2. The attack analysis support apparatus according to claim 1,
wherein search, with use of a search condition that was set in advance and is for searching for noise, for noise information that matches the search condition, from the noise information generated by the noise information generating means.

3. The attack analysis support apparatus according to claim 1,
wherein determine whether or not the observation is noise with use of the noise information, and deleting the observation from the storage device in a case of determining that the observation is noise.

4. The attack analysis support apparatus according to claim 1,
wherein generate output information for outputting the generated noise information to an output device; and
acquire modification information, which is for modifying the conversion information and was generated by a user based on the noise information, and modify the conversion information based on the acquired modification information.

5. An attack analysis support method in which a computer:
acquires a predicate indicating a type of an attack included in an observation indicating a trace of the attack, or an observation type indicating a type of the observation corresponding to the predicate;
generates a noise condition by, with use of selection information that is included in conversion information associated with the predicate or the observation type and is for selecting conversion target data included in log management information for managing a log, selecting conversion target data from the log management information, and converting the selected conversion target data based on conversion method information included in the conversion information; and
generates noise information to be used for determination of whether or not the observation is noise, in accordance with the noise condition generated for the log management information.

6. The attack analysis support method according to claim 5, wherein the computer:
searches, with use of a search condition that was set in advance and is for searching for noise, for noise information that matches the search condition, from the generated noise information.

7. The attack analysis support method according to claim 5, wherein the computer:
determines whether or not the observation is noise with use of the noise information, and deletes the observation from the storage device in a case of determining that the observation is noise.

8. The attack analysis support method according to claim 5, wherein the computer:
generates output information for outputting the generated noise information to an output device; and
acquires modification information, which is for modifying the conversion information and was generated by a user based on the noise information, and modifies the conversion information based on the acquired modification information.

9. A non-transitory computer-readable recording medium that includes a program recorded thereon, the program including instructions that causes a computer to carry out the steps of:
acquiring a predicate indicating a type of an attack included in an observation indicating a trace of the attack, or an observation type indicating a type of the observation corresponding to the predicate;
generating a noise condition by, with use of selection information that is included in conversion information associated with the predicate or the observation type and is for selecting conversion target data included in log management information for managing a log, selecting conversion target data from the log management information, and converting the selected conversion target data based on conversion method information included in the conversion information; and
generating noise information to be used for determination of whether or not the observation is noise, in accordance with the noise condition generated for the log management information.

10. The non-transitory computer-readable recording medium according to claim 9,
wherein the program causes the computer to carry out the step of:
searching, with use of a search condition that was set in advance and is for searching for noise, for noise information that matches the search condition, from the generated noise information.

11. The non-transitory computer-readable recording medium according to claim 9,
wherein the program causes the computer to carry out the step of:
determining whether or not the observation is noise with use of the noise information, and deleting the observation from the storage device in a case of determining that the observation is noise.

12. The non-transitory computer-readable recording medium according to claim 9,
wherein the program causes the computer to carry out the steps of:
generating output information for outputting the generated noise information to an output device; and
acquiring modification information, which is for modifying the conversion information and was generated by a user based on the noise information, and modifying the conversion information based on the acquired modification information.
